(19) United States
(12) Patent Application Publication
(10) Pub. No.: US 2003/0216951 A1
(43) Pub. Date: Nov. 20, 2003

(54) Automating resource management for distributed business processes

(76) Inventors: Roman Ginis, Elmsford, NY (US); K. Mani Chandy, La Canada, CA (US)

Correspondence Address: J. D. Harriman II, COUDERT BROTHERS LLP, 23rd Floor, 333 South Hope Street, Los Angeles, CA, 90071, US

(21) Appl. No.: 10/429,599

(22) Filed: May 2, 2003

Related U.S. Application Data
(60) Provisional application No. 60/377,093, filed on May 2, 2002.

(51) Int. Cl. G06F 17/60

(52) U.S. Cl. 705/8

(57) ABSTRACT

The present invention is a method and computer product for automating resource management. One embodiment is a method targeted at solving an optimization problem termed Activity Resource Assignment (ARA). ARA formalizes the selection of optimal resources for activities of a given process. The selection is based on an objective function expressed as an algebraic composition of relationships among the activities. ARA gives a new solution method that finds an optimal solution, in polynomial time, for many seemingly intractable instances. The exponent of the polynomial in the algorithm is related to the tree-width of a relationship graph that can be constructed for any given process specification. ARA is combined with a method targeted to solving the Distributed Service Commit (DSC) problem, which addresses the need to coordinate the resources chosen by an optimization to carry out the business process. DSC is targeted to the issue of achieving an atomic distributed agreement of resources.

This application claims the benefit of U.S. Provisional Patent Application No. 60/377,093, filed on May 2, 2002, the disclosure of which is hereby incorporated by reference.

### BACKGROUND OF THE INVENTION

1. Field of the Invention

The present invention relates to the field of automated resource allocation, and in particular to a method for automating resource management.

2. Background Art

The computer has shown its potential to automate business processes. However, what exists now is just a precursor to a much larger opportunity to automate processes not only on the scale of an enterprise, but on the scale of the entire economy. Spurred by the promise of removing inefficiencies in business through computerization, a massive effort to construct computer networking infrastructure has been undertaken in recent decades to give connectivity to businesses around the world. Yet despite the availability of the new tools, most businesses are still reluctant to conduct transactions over computer networks. It turns out that conducting businesses over computer networks is only marginally more efficient than existing business processes (i.e. face-to-face meetings, paper documents, phone calls, faxes, etc). There are not enough economic incentives for business to change over. Thus simply building computer networks is not enough to remove inefficiencies in existing business processes.

What is needed is a different approach that targets the root of the problem, which is the inherent inefficiencies in business processes. Instead of trying to enable businesses to make transactions using computers, the goal of automation should be removing inefficiencies in current business processes using technology. The focus is on improving the business processes themselves.

Business Processes

Business processes are sets of related activities (or tasks). For example, constructing a new office building is a business process that involves activities such as digging, carpentry and plumbing. Processes arising in crisis management, vehicle manufacturing and travel also consist of discrete activities. An individual traveling to another city performs the activities of flying to and from the destination and using a hotel and a rental car while there. The resources needed for the activities can be people, machines, organizations and even information access rights. The relationships connecting the activities into a process are usually in time, distance, capability, load and cost. For instance, for a traveler there is a time dependency between the arrival of her flight and the check-in time of the hotel room. Viewing this dependency as a function from the flight and hotel choices to value, would probably give a good value if the time difference is small and a progressively poor value with the larger difference. Similarly, a relationship in cost between the ‘to’ and ‘from’ flights could be represented by a function that may have a high value if the flights are operated by the same provider and low otherwise.

Compositional Business Processes

Compositional business processes are usually conducted, for example, among businesses within a service-oriented, free-market economy. In such an example economy, the consumers can locate the potential resources and communicate and negotiate with them electronically. The parties involved can lease the services of machines, individuals and organizations to perform each of the activities of a process and deduce a value from a completed process depending on the degree to which the chosen resources satisfy the relationships among the activities.

Efficient Business Processes

An efficient business process can be described as one where all activities are satisfied to the best degree possible. The relationships can be in time, space, combined resource usage or any other dimensions. The important inefficiencies in business processes today are in the myriad of “small” and “short term” transactions that businesses want to do with each other on a daily or hourly basis. These transactions involve communications between people and their transportation from place to place, energy utilization and having enough work for employees, consultants and contractors.

With regard especially to the two fundamental issues of selection and commitment in business processes, these inefficiencies can be solved by a new type of computerization: novel systems and optimization algorithms that not only allow one computer database to talk to another, but that efficiently manage the resources used for different tasks—namely people's time, energy, communications and physical facilities of the firms.

Up to now, businesses have been trading services in large “chunks” and long timeframes. For example, people are employed for months or years and network connections are sold on monthly contracts. One of the reasons for this is the management difficulties in dealing with a large number of different business components. However, if this hassle were reduced by new automation technology, the opportunity to make businesses leaner may drive companies to achieve a new economic optimum.

### SUMMARY OF THE INVENTION

The present invention is a method for automating resource management. One embodiment of the present invention is a method targeted at solving a problem termed Activity Resource Assignment (ARA). ARA is an optimization problem that formalizes the selection of optimal resources for activities of a given process. The selection is based on an objective function expressed as an algebraic composition of relationships among the activities. Thus solving ARA satisfies the important issue of selection in the compositional business process. The ARA problem is a special type of Integer Programming for which the embodiment gives a new solution method that finds an optimal solution, in polynomial time, for many seemingly intractable instances. The exponent of the polynomial in the algorithm is related to the tree-width of a relationship graph that can be constructed for any given process specification.

Another embodiment of the present invention is a method targeted to solving the Distributed Service Commit (DSC) problem, which addresses the need to coordinate the resources chosen by an optimization to carry out the business process. DSC is targeted to the issue of commitment in the compositional business process. Since the resources are distributed, independent and traded in a marketplace, achieving an atomic distributed agreement among them requires both an algorithmic and an economic approach. The present invention offers a solution that combines distributed computing techniques with financial derivatives to achieve the required collective agreements. It is a generalization of the two-phase commit synchronization protocol with the American call option financial instrument.

Together the solutions to these two basic problems (ARA and DSC), intrinsic to their environment, can help automate and efficiently optimize resource management for many business processes.

Activity Resource Assignment (ARA)

Solving ARA involves finding an optimal assignment of a collection of resources to a collection of tasks that need to be performed. For example, the collection of tasks can be building tasks related to the construction of a house (plumbing, excavation, wiring, etc.). The collection of resources can be the available plumbers, electricians, machinery, etc. that can perform those tasks. The goal of optimization is to assign resources to the tasks such that a certain number of factors can be satisfied. In a simple example, one factor may be the optimization of cost, where the optimal solution is the one that chooses the cheapest available resources. The challenge is that, real-life optimization problems involve solving assignment for a large number of tasks, resources, and factors.

The first step toward solving the assignement problem is to abstract it into a mathematical model. The model is comprised of three parts: the variables, the relationship functions, and an objective fucntion. The present invention assumes that a business process consists of n activities, each of which requires one resource. Furthermore, it is assumed there are at most m different resources available for assignment to each activity. Thus, each activity is modeled as a variable χᵢ, 1≦i≦n that takes values in the set M={1, . . . , m}. Namely, by χ₅=7 means that activity #5 is assigned resource #7 out of the m available for it.

Then the model further defines the relationships between resources as functions ƒᵢ, 1≦i≦k. A function ƒᵢ takes as parameters a set of activities and gives a value describing the user preference for each configuration of resources that could be chosen for the activities. For instance, if function ƒ₁(χ₁, χ₂) is specified for the problem, it gives a positive real value for every assignment of resources for activities 1 and 2. It can be described as a table of size m×m rows. For example, ƒ₁(χ₁=1, χ₂=3)=27, ƒ₁(χ₁=2, χ₂=3)=6.

These relationship functions are given as input to the problem. It is assumed that they are generated from consumer preferences. In a business trip example, the airlines may offer cost savings to the consumer if he were to choose the same airline for all flights in the trip. This information can be translated into a function ƒ₁ that relates all the flight resources in the business trip process. For example, if the business trip has two flights (to and from some destination) designated as activities χ₁ and χ₂, then the “same airline” discount can be represented as follows: ƒ₁(χ₁=“united”, χ₂=“united”)=100, ƒ₁(χ₁=“delta”, χ₂=“delta”)=70, and otherwise ƒ₁=0. This implies that ƒ₁(χ₁=“united”, χ₂=“delta”)=0.

The last part of model is the objective function ø. It establishes the importance of various relationships to each other by casting them in an algebric expression. An example objective function may be ø=ƒ₁^{ƒ}+ƒ₅ƒ₃+ƒ₄. While there is no restriction on the shape of ø, its “topology” (the arrangement of relationship functions and operators on them) has major implications on the computational complexity of the solution method.

Finally, a solution to the problem is an assignment of a resource to each activity, and the optimal solution χₒₚₜ is an assignment that maximizes ø. It describes which resource needs to be assigned to which activity to get the most benefit to the consumer based on the specified preferences.

Solution to the ARA Problem

An embodiment of the present invention is a deterministic method to solve a class of discrete non-linear optimization problems relevant to business process optimization. It solves the problem through a reduction operation (called relaxation) that recursively transforms a problem instance to a simpler one while preserving an optimal solution. This is achieved by way of defining a relaxation operator, ρ_{χ}(S), which returns an optimal value of variable χ ∈ X for any assignment of variables in S⊂X with respect to ø. Thus when a variable χ is relaxed, it is replaced by ρ_{χ}(S) everywhere in ø, making ø no longer a function of χ. With S carefully chosen the relaxation reduces the problem by one variable, at a computation cost of O(m^{|S|+1}), yet at least one maximum is preserved. The problem can thus be reduced one variable at a time, until only one remains. At that point, a solution can be obtained by iterating all values for that variable, solving the assignment for that variable and recursively applying that solution for the rest of the variables.

The solution method is outlined in FIG. 1. First, a business process is mapped to a problem instance (10). The method has a nice property that one can first obtain the complexity of solving it (14) without carrying out the solution.

In one embodiment, once a bunsiness process is mapped to the problem instance, the method performs structural analysis of the objective function ø(step 12). Structural analysis involves several operations. The first is called dependency separation. The dependency arises from the relationships among tasks. For example, one of the relationships may reflect the requirement that a plumber must start work after the carpenter is done and another relationship may reflect the preference that the plumbing begins as soon as possible.

The method uses the observation that for any χ, a dependent set D_{χ}⊂X, can be found such that ρ_{χ}(X)=ρ_{χ}(D_{χ}). It is often the case that |D_{χ}|<<|X|, making the time to generate ρ_{χ}(S) tractable. In essence the finding of the depedent set narrows down the number of variables that need to be considered in the process of relaxation, hence speeding up the overall solution process. D_{χ} can be determined from the structure of the objective function ø. The present invention has methods for finding D_{χ} all algebraic ø. Using this approach, the final computation cost of the complete reduction is the sum of the costs to generate the relaxation functions ρ_{χ}(S) for each variable.

The method also takes into account an importance issue of using dependency sets to guide the relaxation process. Since relaxing a variable χ makes all of the variables in D_{χ} mutually dependent, relaxing them in the “wrong order” can lead to a much costlier route to an optimal than needs to be.

To obtain the optimal ordering of relaxation, the method of the present invention also produces a dependency graph in the structual analysis step. Using the depedency graph, the method figures out an order for relaxing the variables. Two approaches are used. The first one is based on tree-decomposition of graphs that allows for the variables to be partitioned into special sets and then apply the relaxations separately to each set, yielding a dynamic programming solution. The second approach uses one of two heuristics that select the variables to relax in a greedy way based on simple local properties: a) relaxing the variables with the least number of dependent variables first, or b) relaxing the variables which create the least number of new dependencies first.

The tree-decompositon method is optimal cost (note that with either approach the optimal resource assignment is always found, merely at different costs) for certain types of problem topologies, and it works reasonably well for many others. The heuristics work remarkably well on all the cases that were tested, returning results that were comparable to the optimal cost. However these heuristic approaches are provably not optimal.

The structural analysis step (12) in the figure works in linear time and determines whether it has a “good” topology for both the tree-decomposition approach and the heuristics approach. It computes the exponent of the computation polynomial without even running the optimization. This allows one to choose the better method for each problem instance.

Two results are obtained from the structural analysis step (step 12). Outcome 14 shows both of them: an optimal ordering of variable relaxation and the complexity of the problem. Knowing the complexity before solving the problem allows the computing entity to know the computing costs up front and make a decision as to whether to proceed. Thus, the problem of attempting a calculation that takes an unacceptable amount of time to complete can be avoided. Also, given a scenario, a certain guarantee can be made about how much computing time and resource are needed.

If the complexity of a problem is deemed acceptable, then the solution process is executed in step 16. The relaxation is performed according to the relaxation order in outcome 14. The varible is relaxed one by one until only one variable is left. At that point, a solution can be obtained by iterating all values for that variable, solving the assignment for that variable and recursively applying that solution for the rest of the variables. The solution is finally obtained in outcome 18. The solution is guaranteed to be an optimal solution.

Distributed Service Commit

Another embodiment of the present invention is a method to reserve resources. This is a logical and useful extension of solving the ARA problem. Once the optimal assignment is received, the remaining problem becomes one of coordinating the actual reservation process. The reseveration embodiment is a method that solves a problem called Distributed Service Commit (DSC). DSC takes care of the commitment aspect of the component business processes mentioned in the background section. Before DSC is described, several terms are introduced here.

A resource is a service or an entity that can perform some function. It can be scheduled or reserved for a duration of time and has a unique name—a URL (Universal Resource Locator). Furthermore, it is supervised by a software ‘manager’ that enables other entities to reserve and release the resource and to determine when the resource is available. An example of a resource is a carpenter, whose software manager is a program that maintains his schedule.

A consumer is any entity that attempts to reserve one or more resources to perform a business process. For example, a construction company behaves as a consumer when it reserves some carpenters, plumbers, electricians, etc. to build a house. It can also act as a resource, when some other firm hires it to erect a building complex, along with possibly other service providers, such as an accounting firm to oversee the operation and a bank to loan the money for the construction.

A distributed system is a set of computers able to exchange messages. It can be as small as a system that supports a workgroup in a company or as large as the Internet. The fundamental property that makes it harder to engineer applications for distributed systems than programs for personal computers is the uncertainty about the state of the system. Namely, because of the intrinsic delay in communication between any two computers, no computer in a system knows the exact state of its peers. For example, no bank computer knows for certain whether its ATM machines are operating correctly at any given moment, because even though they can exchange messages, by the time an ATM's message reaches the bank, the ATM may have lost power.

Now, if the resources and the consumers are modeled as a distributed system, the state of interest to the consumers is (at least) the availability of the resources they select for their business processes. The Distributed Service Commit (DSC) problem model that is used in the present invention requires a consumer to obtain a commitment from a resource for each activity in order to execute the process. A commitment by each resource to provide a service at a specified time is a type of distributed agreement that the consumer must achieve in its distributed system.

DSC and Its Solution

In the present invention, the DSC embodiment is an economically-inspired method to solve the distributed agreement problem. The idea is to use short-term financial contracts to mitigate risks and opportunity costs during transactions between consumers and resources.

The model assumes a consumer C and a set of resources \dot{χ}₁, . . . , \dot{χ}ₙ, which the consumer wants to reserve. DSC requires the consumer to reserve all n resources atomically, all together or none of them, for the business process to succeed (if the problem instance permits for a subset of the resources to be reserved atomically instead of all of them, the DSC problem is still relevant for that subset). To do this, C can send messages to any \dot{χ}ᵢ and attempt to reserve it. Two types of messages are possible: either the consumer requests a commitment from \dot{χ}ᵢ (if it is available), or it asks the resource to wait until it ensures that all the other resources are also available and are in a waiting state. In this way the consumer can either get all the resources into a waiting state called “poised to be reserved,” or at least one of them is unavailable and the agreement among this set of resources is not possible.

While this protocol of interaction could work well in the typical resource allocation problems, it is unreasonable to expect that the resources in an economy would want to be in a waiting state for free while some consumer is attempting its atomic reservation. From the point of view of the resource, asking the resource to wait is equivalent to using the resource. There is an opportunity cost associated with waiting and either the consumer or the resources must absorb it. To address this problem we propose using a financial instrument we call Micro-Option during the reservation process. Micro-Option is derived from the common American Call Option instrument adapted to services instead of commodities and integrated with our expected mode of consumer-resource interaction. A Micro-Option is a short-term right to reserve a resource at some specific time in the future for a specific price. This right has a duration (e.g. a few seconds or minutes) and a value which, in a free market, is closely related to the opportunity cost of the resource for that duration. Micro-Options can be implemented efficiently with very low transaction costs.

Thus, a consumer who wants to reserve n resources can execute a two-phase algorithm where he first attempts to purchase the rights to reserve the resources, and if he is successful at obtaining all the rights, he then proceeds with the reservation. In this way, the resources can get compensated for waiting while they are being evaluated for reservation and the consumers need not waste funds by paying for the reservations without knowing that all the resources are obtainable.

Along with the ARA model, the present invention solves the assignment problem and reservation problem that are commonly encountered in business processes. For example, a business may use ARA method to solve for an optimal assignment and then turn to the DSC method to reserve all the resources specified by the optimal assignemnts.

### BRIEF DESCRIPTION OF THE DRAWINGS

These and other features, aspects and advantages of the present invention will become better understood with regard to the following description, appended claims and accompanying drawings where:

FIG. 1 outlines the solution process in the ARA method of the present invention;

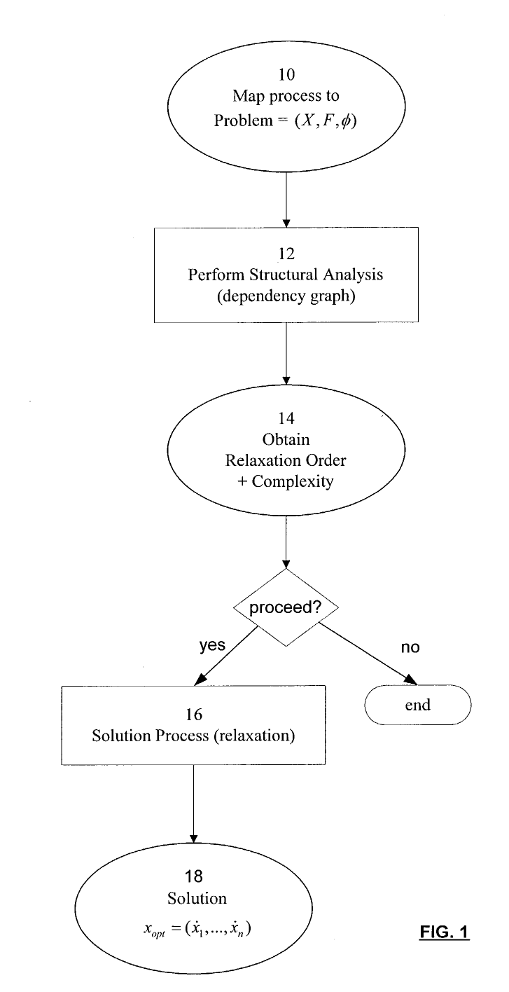

FIG. 2 shows how a solution can be obtained via the relaxation process for a sample problem;

FIG. 3 shows the main steps in the ARA method of the present invention;

FIG. 4A depicts an example vertex elimination procedure;

FIG. 4B outlines the vertex elimination procedure;

FIG. 4C outlines an alternate vertex elimination procedure (heuristic method);

FIG. 5 shows an example tree-decomposition process according to an embodiment of the present invention;

FIG. 6 shows two examples of using heuristic-based methods of obtaining the relaxation order;

FIG. 7 is a flowchart showing the process under taken by the consumer entity in the Distributed Service Commit method of the present invention; and

FIG. 8 is a flowchart showing the overall process of the Distributed Service Commit method of the present invention.

FIG. 9 illustrates a general computer embodiment used in the present invention.

### DETAILED DESCRIPTION OF THE INVENTION

The present invention is a method for automating resource management. Embodiments of the present invention comprise of methods that help solve assignment optimization and reservation commit problems that are frequently encountered in business processes. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

One embodiment of the present invention is a method targeted at solving a problem termed Activity Resource Assignment (ARA). ARA is an optimization problem that formalizes the selection of optimal resources for activities of a given business process. A simple example may be the selection of optimal construction resources for the building of a house. Given a set of electricians, plumbers, contractors, etc., how can one choose the best combination of resources to satisfy constraints such as budget, scheduling, etc.?

Another embodiment of the present invention is a method targeted at reserving resources in real-time and distributed environments. The method, called Distributed Service Commit (DSC), takes into account opportunity costs involved in holding reservation of resources and guarantees that all needed resources are either reserved all together or not at all. The atomic nature of the reservation model is necessary because the optimality of the resource assignments (obtained in the ARA method) is dependent upon the usage of all resources specified in the optimal solution. In one embodiment of the present invention, in conjunction with the ARA method, the consumer can select the best resources and reserve them in a single transaction. In the following sections, the ARA method is first described, followed by the description of the DSC method and how the two can be used in conjunction. A computer embodiment is shown afterward. Finally, Appendix A is included to provide a more detail discussion and mathematical proofs of the methods disclosed in the present invention.

1 ARA

The method of the present invention formalizes business processes into ARA models. In many instances, the method yields an optimal solution in polynomial time. In the disclosure, first a detailed description of the ARA problem is presented. The relevant sections describe how a business process is mapped into an ARA problem. Then, in the next several sections that follow, the method that solves the ARA problem is presented step by step.

1.1 Components of ARA

The ARA problem has three major components—a set of discrete variables X, a function set F and an objective function ø. These three components are further described in the next three sections.

1.1.1 Variables

Suppose there is a business process P and that P can be defined by a set of activities 1, . . . , n. Further suppose that each activity i can be performed by any of M resources. For example if i is the ‘plumbing’ activity in a building construction project, then there are m different plumbers who could potentially do this work. For a carpentry activity j there are also m carpenters to choose from. If there are fewer than m resources for a given activity, then it is assumed that there are “fake” resources to bring the total up to m where the fake resources have exorbitant costs over exorbitant time. Since the goal is to look for an optimal solution (e.g. lowest cost, fastest time), these fake resources will not become part of the final solution.

The problem definition associates a variable χᵢ with each activity i, which can take one of m values. For example, if the ‘third plumber’ from the M available plumbers is chosen, the equation representation would read χᵢ=3. The set of discrete variables X thus comprises of all the variables χ₁, . . . χₙ. The goal of solving the problem is to assign a value to each χᵢ for all 1≦i≦n. In other word, the solution is obtained when exactly one resource has been assigned to each activity.

1.1.2 Relationship Functions

The challenge of finding the optimal assignment arises because there are usually some resource constraints among the activities that need to be satisfied. For example, airline flights that are part of a business trip may be required to start and end on a specific day. This requirement is absolute and immediately restricts the set of possible options. Also, a consumer is interested in identifying the resources that maximize the utility of his business process based on some subjective preferences. Following along in the house building example, suppose that a plumber (activity i) must start work after the carpenter (activity j) is done and the preference is to have the plumbing begin as soon as possible. This preference can be represented by a relationship function ƒ₁(χᵢ, χⱼ) to indicate the time preference. For each of the m² combinations of plumbers and carpenters, it gives a ‘value’ that shows how well each pair satisfies the ‘as soon as possible’ relationship. For example, for the given carpenter, say χⱼ=4, if plumber 2 can start work sooner than plumber 3, then 2 would have a higher relationship value than plumber 3 (i.e. ƒ₁(χᵢ=2, χⱼ=4)>ƒ₁(χᵢ=3, χⱼ=4)). Of course, for a different carpenter the value of the relationship function for each plumber may be entirely different. For another carpenter, plumber 3 may have a higher relationship than plumber 2 because the carpenter's schedule is now different and may suit plumber 3 better.

| x₁ | x₂ | utility |
|---|---|---|
| 1 | 1 | 5 |
| 1 | 2 | 10 |
| 1 | 3 | 2 |
| 2 | 1 | 20 |
| 2 | 2 | 16 |
| 2 | 3 | 8 |
| 3 | 1 | 1 |
| 3 | 2 | 9 |
| 3 | 3 | 11 |

The relationship between the carpenter task and the plumbing task exemplifies the simplest type of relationship, which is a binary relationship between two activities. This type of relationship is formally represented as a function ƒᵢ:χ₁×χ₂→R⁺, where χ₁ represents carpenteres and χ₂ stands for plumberes. The function takes the resources for each activity and gives a value of the relationship for each pair. From the optimization standpoint, it is irrelevant why a certain carpenter and a certain plumber give a higher value for ƒᵢ. Thus, it is assumed that there would be a tool that would map from the semantics of a given problem to the algebraic specification. Furthermore, the function representing any relationship can be absolutely arbitrary. No assumptions are made about how they were derived and the method of the present invention does not make any assumptions about the function shapes.

The values for a given activity are discrete and the number of values is bounded. A function that relates two activities, χ₁ and χ₂, and assigns utilities (or values) for different resource configurations can be represented by a table as shown in Table 1.

More generally, one can define a relationship ƒⱼ that takes as parameters any number of activities (including all of them). In other words, the relationships can be n-ary, forming functions of up to n parameters. This allows the model to describe a wide range of physical and economic relationships between the activities of a business process. For instance, in the travel example, it is possible to model a price discount if some specific configuration of flights and hotels were chosen (such as if they were operated by the same firm). Since cost is often a factor in the utility of a resource to the consumer, the values of such ‘discount’ relationships would be higher for ‘same firm’ resource configurations.

1.1.3 Objective Function

Of course, a problem can have many relationships among the activities. In the house building example, there may be one relationship among the task of carpentry, the plumbing task, and the heating system task; another relationship between the roofing task and the painting task; and another relationship between the carpentry task and the electrical wiring task.

Since not all relationships are equal in importance and the relationships themselves maybe related in some way, the problem further defines how the relationships are to be considered. This allows the problem to specify a set of utility relationships favoring the choice of specific configurations of resources among several activities.

To assign priorities among the relationships, there is one objective function ø that is an algebraic composition of the relationship functions. For instance, a process with five activities {1, . . . , 5} and three relationships {ƒ₁, ƒ₂, ƒ₃} can have the objective function defined as ø=ƒ₁(χ₁, χ₂) * ƒ₂(χ₁, χ₃)+ƒ₃(χ₃, χ₄, χ₅). The goal is to find a solution (an assignment of values to variables χ₁, . . . , χₙ) so as to maximize the value of ø.

In sum, a business process optimization problem (ARA) is given by a triple: (X, F, ø), the set X={χ₁, . . . , χₙ} contains variables corresponding to the activities, the set F contains the relationship functions and ø is an objective function. This is demonstrated by the following example:

Given X, F and ø where X={χ₁, χ₂, χ₃, χ₄, χ₅, χ₆},

$$F = \{ \begin{matrix}{f}_{1} : {x}_{1} \times {x}_{2} \times {x}_{3} \to {ℝ}^{+} \\ {f}_{2} : {x}_{1} \times {x}_{3} \to {ℝ}^{+} \\ {f}_{3} : {x}_{4} \times {x}_{5} \to {ℝ}^{+} \\ {f}_{4} : {x}_{1} \times {x}_{2} \times {x}_{6} \to {ℝ}^{+} \\ {f}_{5} : {x}_{3} \times {x}_{4} \times {x}_{5} \to {ℝ}^{+}\end{matrix}$$

and ø=ƒ₁^{ƒ}^{₂}+ƒ₅ƒ₃+ƒ₄

Find an n-vector χₒₚₜ=(\dot{χ}₁, \dot{χ}₂, \dot{χ}₃, \dot{χ}₄, \dot{χ}₅, \dot{χ}₆) that maximizes ø, where \dot{χ}ᵢ represents an assignment to χᵢ of a value from 1, . . . , m for all 1≦i≦n.

The formal specification of the model is given below:

Let X={χ₁, . . . , χₙ} and M={1, . . . , m}, such that χᵢ takes values in M. Let F={ƒ₁, . . . , ƒₖ} be a set of functions, where each ƒᵢ(Π_{χ∈X}_{ᵢ}): M^{|X}^{ᵢ}^{|}→R⁺, 1≦i≦k and θ⊂Xᵢ⊂X. Let ø: [R⁺]^{k}→R=f[ƒ₁, . . . , ƒₖ] be the global objective function.

ACTIVITY-RESOURCE ASSIGNMENT (ARA): Given X, F and ø find an n-vector χₒₚₜ=(\dot{χ}₁, . . . , \dot{χ}ₙ) that maximizes ø.

1.2 Solving the Problem

Once a business process has been mapped in the afore-described problem definition, the method moves on to several other steps to bring about the solution. The goal to find a solution that maximizes the objective function ø (i.e. the optimal assignment for all the tasks).

The method of present invention takes a divide and conquer approach. It uses a process called relaxation to reduce the complexity of ø. Relaxation takes advantage of the fact that it is possible to create a new function ø′ with only n−1 variables that will share at least one maximum with ø. This replacement is valid if the missing variable, say χₖ, is replaced by a special function ρₖ that always returns the best value for χₖ in ø for any assignment of the other variables. By replacing the variable one at a time, the problem is reduced recursively.

Therefore, the ‘complexity’ of ø can be reduced from being a function of n variables to just a function of one by systematically replacing all the variables by the appropriate ρ functions. The goal is to apply ρ, the relaxation operator, to a problem recursively to reduce it to its base case.

Formally, the operator takes a variable χᵢ ∈X and represents it in terms of the other variables by creating a new function ρ_{χ}_{ᵢ}: m^{X-{χ}^{}}→m, where m is the number of values that each variable in X can take. Then applying it to ø can be written as ø(χ₁, . . . , χᵢ=ρ_{χ}, . . . , χₙ), where ρ_{χ}_{ᵢ} replaces all instances of χᵢ in the syntactic form of ø.

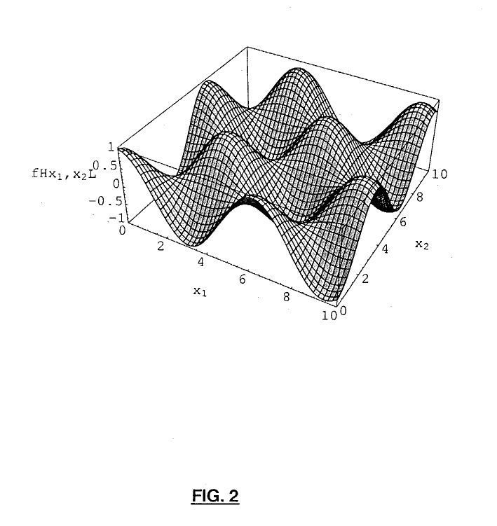

FIG. 2 shows an example of the variable replacement. Let ø=ƒ(χ₁, χ₂)=cos χ₁ * cos χ₂ for discrete χ₁, χ₂. Then a ø′=ƒ(χ₁, ρ_{χ}_{₂}(χ₁)) can be formed such that max ø=max ø′, if ρ_{χ}_{₂}(χ₁) always returns a value for χ₂ where for any χ₁, ø(χ₁, ρ_{χ}(χ₁))≧ø(χ₁, \dot{χ}₂) for all assignments \dot{χ}₂ of χ₂. Then a maximum of ø can be found by simply iterating over all values of ø₁.

1.2.1 Brief Overview of Solution

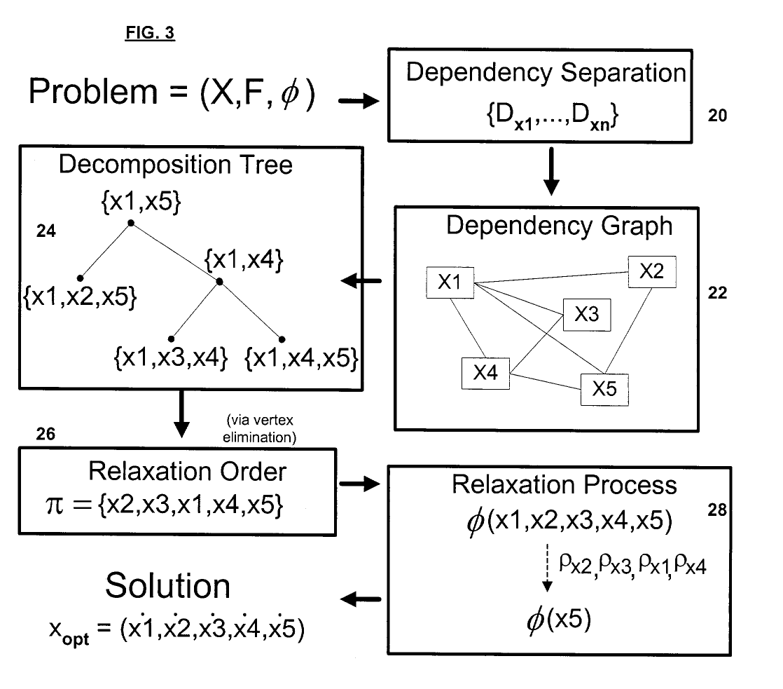

There are several steps that need to take place before the relaxation process can be performed. FIG. 3 shows the overall steps involved in the solution method of the present invention. First, in step 20, the structure of the problem is analyzed through dependency separation. Then in step 22, a dependency graph is created based on the result of the dependency separation step. In step 24, a decomposition tree is formulated using the structure of the dependency graph. In step 26, an algorithm is used to transform the decomposition tree into a relaxation order. Obtaining a proper relaxation order is important in ensuring that the relaxation process is performed efficiently in in step 28. The outcome of step 28 is the solution itself. The individual steps are further described in the sections that follow.

1.2.2 Performing Dependency Separation

The solution process begins with the performing of dependency separation in step 20. This is the first step because finding a good dependency separation for all variables in X can lead to a faster computation in later steps.

The idea of dependency separation stems from these observations:

It is possible to compute such ρ_{χ}_{ᵢ} functions for the problems in question because all the variables in X are discrete.

If no assumptions are made about the shapes of the component functions ƒ's an exhaustive search seems like the only option. The brute-force approach would take m^{|X|} time.

Yet, if ø has a certain structure, for instance being a sum of products of ƒ's, then the computation can be simplfied by identifying, for any given χᵢ, a set of dependent variables D_{χ}_{ᵢ} ⊂ X, with the property that ρ_{χ}_{ᵢ}(χ₁, . . . , χᵢ₋₁, χᵢ₊₁, . . . , χₙ)=ρ_{χ}_{ᵢ}({χ|χ∈D_{χ}_{ᵢ}}). This implies, that all the independent variables, \overline{D}_{χ}_{ᵢ}=X−D_{χ}_{ᵢ}, are irrelevant in finding the maxima of ø with respect to χᵢ and can therefore be ‘omitted’ in the search by being set to any legal values.

Thus in this step the method takes advantage of the structure of ø and eliminates the need to perform an extensive search. The problem is thus reduced to a simplier one. For the fastest computation of ρ_{χ}_{ᵢ}, |D_{χ}_{ᵢ}| is desired to be as small as possible, as the cost of computing ρ_{χ}_{ᵢ} is then m^{|D}_{χ}_{ᵢ}^{|}. To this end, the method presents a set of rules to identify the dependent variables for common structures for ø. While, this is not always possible, for many applications the sizes of the dependent sets are substantially smaller than n. The set of rules are presented in more details in Section 5.2 of Appendix A. Briefly, they are:

1. ø=a sum of ƒ's or a product of ƒ's.

2. ø=sum of products, product of sums

3. ø=sum of exponents, exponent of sums

4. ø=product of exponents, exponent of products

For the sum of ƒ's, let

$$φ = {\sum }_{i = 1}^{n} {f}_{i}$$

and let χᵢ≠χⱼ ∈X. Then χᵢ is independent of χⱼ if there does not exist an Xₜ, 1≦t≦k, such that χᵢ, χⱼ ∈Xₜ.

For the product of ƒ's, let

$$φ = {\prod }_{i = 1}^{n} {f}_{i}$$

and let χᵢ≠χⱼ ∈X. Then χᵢ is independent of χⱼ if there does not exist an Xₜ, 1≦t≦k, such that χᵢ, χⱼ ∈Xₜ.

For the sum of products, let

$$φ = \sum {\prod }_{i = 1}^{n} {f}_{i}$$

and let χ≠χⱼ ∈X. Then χ is independent of χⱼ if there does not exist an Xₜ, 1≦t≦k, such that χ, χⱼ ∈Xₜ AND ø cannot be written as ø=Π_{ƒ}_{ᵢ}_{∈B} ƒᵢ(χ)[S] * Π_{ƒ}_{ᵢ}_{∈A} ƒᵢ(χⱼ)[S]+Π_{ƒ}_{ᵢ}_{∈D} ƒᵢ(χ)[S] * ΣΠ_{ƒ}_{ᵢ}_{∈C} ƒᵢ(χⱼ)[S]+ΣΠ_{ƒ}_{ᵢ}_{∈E} ƒᵢ[χ, χⱼ, S] where A, B, C, D, E ⊂ F and S=X−{χ, χⱼ} and sets C and E could be empty.

Section 5.2 of Appendix A provides more details for sum of exponents and products of exponenets rules.

1.2.3 Obtaining Dependency Graphs

The relaxation process can take a substantially different computation time depending on the order in which the variables are relaxed. The difference can range from an exponential time to a low-degree polynomial. Because of this, the method obtains a dependency graph in step 22 to help decide which χᵢ to relax. The graph enables the dependencies among the variables to be easily understood. In particular, it shows what happens to the variables during a relaxation process.

This is the definition of the dependency graph:

An undirected, simple graph G=(V,E) is a dependency graph for an optimization problem R=(X, F, ø) if there exists a bijection between the variables X and the vertices V and there is an edge (νᵢ, νⱼ) ∈ E if and only if χᵢ depends on χⱼ (corresponding to the vertices νᵢ and νⱼ via the bijection) or visa versa.

Basically, the graph is used to correlate the process of relaxation to a well-known graph theory idea of vertex elimination. This is significant because, for certain large classes of graphs, it is possible to find good bounds on the total cost of a vertex elimination process. Thus knowing the correlation would allow the cost of the relaxation process on ø to be obtained easily.

This is how the graph is correlated to the relaxation: the method defines a function η_{ν}_{ᵢ} that transforms a graph G into G_{ν}, where G_{ν}_{ᵢ} is the dependency graph after the relaxation of variable χᵢ. η_{ν}_{ᵢ} is a graph dual of the relaxation operator ρ_{χ}_{ᵢ} and it adjusts the vertices and edges in the dependency graph G after a relaxation to maintain the problem-graph correspondence. In other word, when each variable is relaxed, the graph mirrors the relaxation by eliminating the corresponding vertex making subsequent edge adjustments.

Specifically, relaxing a variable χᵢ removes it from X and creates a new function ρ_{χ}_{ᵢ}. The relaxation makes all the variables in D_{χ}_{ᵢ} dependent on each other if they were not so before. This is how the graph mirrors the relaxation: the transform η_{ν}_{ᵢ} removes the corresponding vertex νᵢ from V and connects, by edges, all the neighbors of νᵢ that were not already connected. This operation is called vertex elimination.

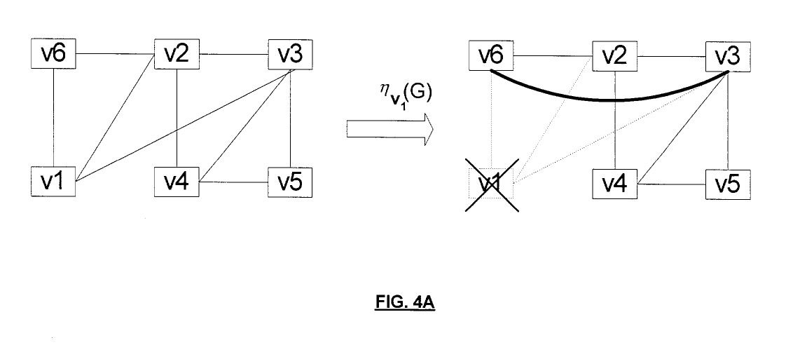

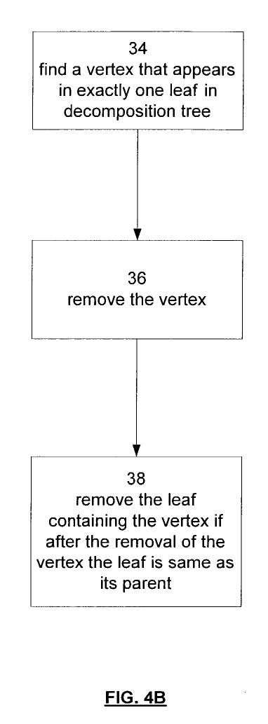

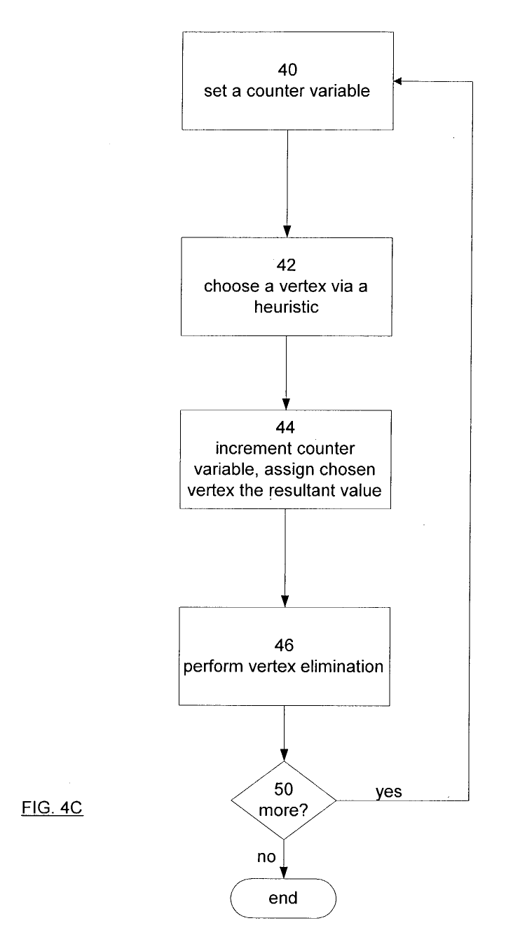

An example of a vertex elimination is shown in FIG. 4, which shows a “before” depiction on the left and an “after” depiction on the right. The example shows that ν₁ has neighbors ν₂, ν₃, and ν₆ (i.e. there is an edge from ν₁ to each of these vertices). When ν₁ is removed, the edges coming from ν₁ are also removed (as shown by the dotted line). The process connects ν₂, ν₃, and ν₆ to one another, if they are not already connected. The only edge that needs to be added (bold in FIG. 4) is the one from ν₃ to ν₆, since the other needed edges were already in place.

It must be noted that the neighbors of νᵢ always correspond to dependent set D_{χ}_{ᵢ}. Therefore, when χᵢ is relaxed, all of its neighbors appear in a newly formed ρ₁₀₂ _{ᵢ} function as parameters, which requires new edges in the graph to reflect the new dependencies. As can be seen, the method establishes an equivalence relationship between the relaxation process on a problem and a vertex elimination process on its dependency graph.

Now, as stated earlier the computational complexity of generating the function ρ_{χ}_{ᵢ} is O(m^{|D}^{_{χ}}^{|+1}). Since each vertex in the dependency graph corresponds to a variable in X and since there is an equivalence between the relaxation and elimination processes, the cost of relaxing χᵢ can be expressed in terms of the neighbors of νᵢ, N_{ν}_{ᵢ}, namely m^{|D}^{_{χ}}^{ᵢ}^{|}=m^{|N}^{_{ν}}^{ᵢ}^{|}. Thus, if vertices are eliminated in the order that minimizes the cost, then the same relaxation order for variables in X would yield a bounded cost on carrying out the relaxation process (i.e. the time complexity to solve the optimization problem).

1.2.4 Performing Graph Decomposition

Recall that since there is a relationship between the graph and the relaxation process, having the graph is needful for finding a good order for relaxation.

Generally speaking, finding a polynomial relaxation order, (i.e. finding an ordering of variables in X for a relaxation process to solve a given problem in polynomial time) for an arbitrary graph is difficult. That is likely a NP-hard problem. However, often one can get a good upper bound on the cost of the relaxation process by performing a tree-decomposition on the dependency graph. Thus, after the graph is obtained in step 22 of FIG. 3, in step 24, a tree-decomposition is performed on the graph to yield a constant tw called tree-width. Tree-width provides a good metric for graph complexity.

The Tree-decomposition theory is a well-known and well-worked on theory in the art. It has been generalized to show that many NP-hard graph problems can be solved in polynomial time for graphs with known tree-width.

Here is the definition for graph decomposition:

A graph decomposition for a dependency graph G constructs a decomposition tree D=(T, ν), where T is a tree and ν={Vₜ}_{t∈T} is a family of vertex sets Vₜ⊂V(G), indexed by the vertices t∈T. Each node t∈T corresponds to a set of vertices Vₜ≡ν(t) in G. The tree-width tw of D is the number of vertices in the largest Vₜ.

For example, in FIG. 3 the tree in step 24 corresponds to the graph in step 22. The leaves in tree T contain all the vertices of G. The internal nodes, the sets {χ₁, χ₅} and {χ₁, χ₄}, separate the graph into cells such that there are no edges in G between the vertices from the separate cells. Thus, each leaf of T corresponds to a cell in G. A cell is defined as a sub-graph where each vertex is connected to all other vertices within the cell. For example, one of the bottom leaves is {χ₁, χ₄, χ₅}. One can see that in the graph these three vertices are fully connected to each other and they form a cell. This example leaf, along with the leaf {χ₁, χ₃, χ₄}, share the parent node of {χ₁, χ₄}, because they both have {χ₁, χ₄} within their cells.

This ‘vertex isolation’ property of the tree is very important for an efficient time complexity relaxation. Because the vertices in separate cells of the graph share no edges, all the vertices can be eliminated within a cell without creating any edges other than to the other vertices in the same cell. Thus if the method removes a vertex located in a hypothetical cell, say cell number 1, the method does not have to be concerned about creating new edges in any vertex that is not in cell number 1. In relation to relaxation, this means that if the variables are relaxed corresponding to the vertices in a cell, then all the new dependencies created will be to other variables within the same cell (recall the process shown in FIG. 4A). Thus the process of relaxation can be isolated to a specific cell, greatly improving the efficiency of the process.

This property allows us to bound the cost of eliminating the vertices and correspondingly relaxing the variables to solve our optimization problem to at most O(ø_{c} * n * m^{tw}), where ø_{c} is the number of algebraic operations in ø, and the relaxation of each of n variables takes at most m^{tw}. This means the problem's complexity is roughly equal to tw.

There are a number of prior art algorithms to decompose graphs into cells with this property. As this is a well-known and active area of research, there is a large class of existing methods that can decompose the typical graphs that will be encountered in the practical application of the present invention. For example, a clique-decomposition method due to Tarjan with a later improvement by Leimer can separate certain types of graphs (for example chordal graphs) in polynomial time or report that they are not separable. Also, Matausek gave a fast method to identify and separate graphs with tree widths≦3. A summary of known decomposition algorithms and graphs they can separate can be found in a table listing on page 43 of Appendix A.

1.2.5 Obtaining Relaxation Order

The last step to do before carrying out the relaxation process is translating a tree decomposition into a relaxation order that can give a polynomial solution to the optimization problem. The relaxation order is obtained in step 26 of FIG. 3.

The relaxation order is immediately available from the tree composition by using the following algorithm:

Input: Let D=(T, ν) be a tree decomposition of G. Then,

1. Find a vertex ν that appears in exactly one leaf Vₜ and label it as next (starting at 1).

2. Remove ν from Vₜ; set Vₜ:=Vₜ−{ν} and if Vₜ−{ν} exactly equals to its parent in T (the separator of Vₜ in the decomposition) then remove the leaf Vₜ from ν.

3. If ν is not empty, repeat step 1.

Output: a vertex ordering π.

FIG. 4B shows the steps involved in vertex elimination. Intuitively, the algorithm chooses a vertex for elimination when it appears in exactly one leaf of the decomposition tree (34). Then the leaf that contains the chosen vertex is removed if, after the removal of the vertex (step 36), the leaf is the same as its parent (step 38). This is done repeatedly until all the leaves are removed. In this way, all the cells of a graph (corresponding to the leaves) are effectively “dissolve” from outside in, by eliminating all the vertices inside each cell. The resulting ordering of vertex removal becomes the desired order for variable relaxation.

An alternative to using tree-decomposition to find a relaxation order is to use a vertex selection heuristic that somehow chooses the order of vertices for elimination. A more detailed description of these heuristics are given in the later section titled “Alternatives to Tree Decomposition.” An experiment was performed with these several heuristics that rely on vertex degrees to choose the vertices for elimination at each step of the relaxation process. The results were surprisingly good, giving computation costs similar to those from tree-decomposition for simpler problem instances and even beating them for many complex instances. An overview of the experimental results can be found in Chapter 7 of Appendix A.

1.2.6 Carrying out the Optimization—Applying the Relaxation Process

In the final step (step 28 of FIG. 3), the actual relaxation is performed. Given a variable ordering π, a relaxation process can directly compute the relaxation ρ functions in the specified order. The variable χ∈X with largest assigned number in the vertex ordering π (obtained from the last step) is the last variable in the objective function ø. Once this last variable is found, a maximum of the objective function ø (with respect to its only remaining variable χ) can be found by iterating over all m of its values and computing the value of ø for each. Once the assignment of χ that yields that largest value of ø is found, the method goes back and solves for the assignment for the rest of the variables. This is an optimal solution to the optimization problem because each ρ_{χ} preserves a maximum of the objective function.

1.3 A Complete Solution to the Example Problem

An example problem is presented to illustrate the steps involved in the method of the present invention.

For convenience the problem is restated:

Given X, F and ø where X={χ₁, χ₂, χ₃, χ₄, χ₅, χ₆},

$$F = \{ \begin{matrix}{f}_{1} : {x}_{1} \times {x}_{2} \times {x}_{3} \to {ℝ}^{+} \\ {f}_{2} : {x}_{1} \times {x}_{3} \to {ℝ}^{+} \\ {f}_{3} : {x}_{4} \times {x}_{5} \to {ℝ}^{+} \\ {f}_{4} : {x}_{1} \times {x}_{2} \times {x}_{6} \to {ℝ}^{+} \\ {f}_{5} : {x}_{3} \times {x}_{4} \times {x}_{5} \to {ℝ}^{+}\end{matrix} \\ and φ = {f}_{1}^{{f}_{2}} + {f}_{5} {f}_{3} + {f}_{4}$$

Find an n-vector χₒₚₜ=(\dot{χ}₁, \dot{χ}₂, \dot{χ}₃, \dot{χ}₄, \dot{χ}₅, \dot{χ}₆) that maximizes ø.

The problem is solved using the five steps outlined above:

1. Dependency Separation

D_{χ}_{₁}={χ₂, χ₃, χ₆},

D_{χ}_{₂}={χ₁, χ₃, χ₄, χ₆},

D_{χ}_{₃}={χ₁, χ₂, χ₅},

D_{χ}_{₄}={χ₂, χ₅},

D_{χ}_{₅}={χ₃, χ₄},

D_{χ}_{₆}={χ₁, χ₂}

For example, the dependent set of χ₁ is {χ₂, χ₃, χ₆} because ƒ₁ has χ₁ as parameter along with χ₂ and χ₃; and ƒ₄ has it with χ₆.

2. Dependency Graph

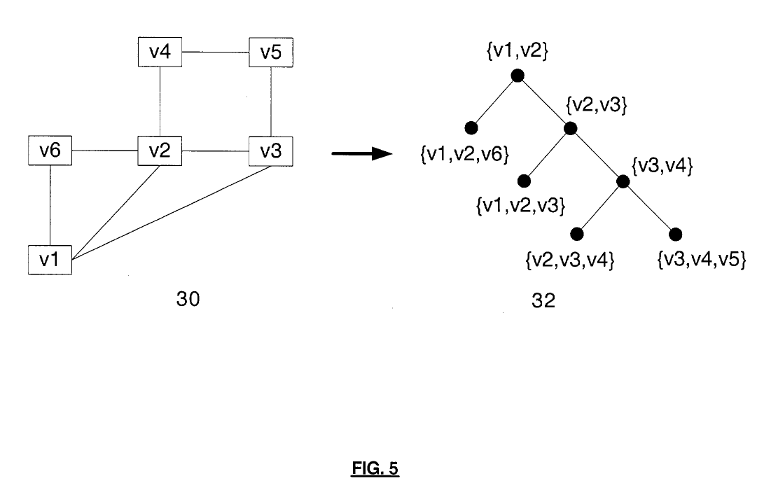

See Graph 30 of FIG. 5. Here the corresponding vertex ν₁ has edges to ν₂, ν₃ and ν₆.

3. Graph Decomposition

Graph 30 can be decomposed into Tree 32 such that the leaves are the cells of the graph and the internal nodes are the separators. For example, {ν₁, ν₂} separates ν₆ from the rest of the graph. There are no edges from ν₆ to any vertices outside of its parent separator.

4. Relaxation Order

For Graph 30 from the Graph Decomposition Step, the order can be assigned as follows: First, it is noted ν₅ appears only in one leaf, the {ν₃, ν₄, ν₅}, so the #1 can be assigned to ν₅. After the assignment, ν₅ is removed from the leaf {ν₃, ν₄, ν₅}. It is observed that the resulting leaf {ν₃, ν₄} is the same as its parent separator. Using the rule from step 2 in the relaxation order algorithm, the resulting leaf is removed from the tree.

Next, it is observed that ν₆ appears only in one leaf, {ν₁, ν₂, ν₆}, so it receives the #2. The rest of the vertices are removed in this fashtion to get the final solution sequence

π={ν₅, ν₆, ν₁, ν₄, ν₂, ν₃}.

5. Applying the relaxation order π to ø

ø₀=ƒ₁(χ₁, χ₂, χ₃)^{ƒ}^{₂}^{(χ}^{₁}^{, χ}^{₃}⁾+ƒ₅(χ₃, χ₄, χ₅)ƒ₃(χ₄, χ₅)+ƒ₄(χ₁, χ₂, χ₆)

relaxing χ₅ [symbol] max ø₁=maxø₀|χ₅=ρ_{χ}^{₅}(χ₃, χ₄) with cost m³

ø₁=ƒ₁(χ₁, χ₂, χ₃)^{ƒ}^{₂}^{(χ}^{₁}^{, χ}^{₃}⁾+ƒ₅(χ₃, χ₄, ρ_{χ}^{₅}(χ₃, χ₄))ƒ₃(χ₄, ρ_{χ}^{₅}(χ₃, χ₄))+ƒ₄(χ₁, χ₂, χ₆)

relaxing χ₆ [symbol] max ø₂=maxø₁|χ₆=ρ_{χ}^{₆}(χ₁, χ₃) with cost m³

ø₂=ƒ₁(χ₁, χ₂, χ₃)^{ƒ}^{₂}^{(χ}^{₁}^{, χ}^{₃}⁾+ƒ₅(χ₃, χ₄, ρ_{χ}^{₅}(χ₃, χ₄))ƒ₃(χ₄, ρ_{χ}^{₅}(χ₃, χ₄))+ƒ₄(χ₁, χ₂, ρ_{χ}^{₆}(χ₁, χ₂))

relaxing χ₁ [symbol] max ø₃=maxø₂|χ₁=ρ_{χ}^{₁}(χ₂, χ₃) with cost m³

ø₃=ƒ₁(ρ_{χ}_{₁}(χ₂, χ₃), χ₂, χ₃)^{ƒ}^{₂}^{(ρ}^{_{χ}}^{₁}^{(χ}^{₂}^{, χ}^{₃}^{),χ}^{₃}⁾+

+ƒ₅(χ₃, χ₄, ρ_{χ}_{₅}(χ₃, χ₄))ƒ₃(χ₄, ρ_{χ}_{₅}(χ₃, χ₄))+ƒ₄(ρ_{χ}_{₁}(χ₂, χ₃), χ₂, ρ_{χ}_{₆}(ρ_{χ}_{₁}(χ₂, χ₃), χ₂))

relaxing χ₄ [symbol] max ø₄=max ø₃|χ₄=ρ_{χ}_{₄}(χ₂, χ₃) with cost m³

$$\begin{matrix}{φ}_{4} = {{f}_{1} ( {ρ}_{{x}_{1}} ( {x}_{2} , {x}_{3} ) , {x}_{2} , {x}_{3} )}^{{f}_{2} ( {ρ}_{{x}_{1}} ( {x}_{2} , {x}_{3} ) , {x}_{3} )} ++ \\ {f}_{5} ( {x}_{3} , {ρ}_{{x}_{4}} ( {x}_{2 ,} {x}_{3} ) , {ρ}_{{x}_{5}} ( {x}_{3} , {ρ}_{{x}_{4}} ( {x}_{2} , {x}_{3} ) ) ) {f}_{3} ( {ρ}_{{x}_{4}} ( {x}_{2} , {x}_{3} ) , {ρ}_{{x}_{5}} ( {x}_{3} , {ρ}_{{x}_{4}} ( {x}_{2} , {x}_{3} ) ) ) + \\ {f}_{4} ( {ρ}_{{x}_{1}} ( {x}_{2} , {x}_{3} ) , {x}_{2} , {ρ}_{{x}_{6}} ( {ρ}_{{x}_{1}} ( {x}_{2} , {x}_{3} ) , {x}_{2} ) )\end{matrix}$$

relaxing χ₂ [symbol] max ø₅=max ø₄|χ₂=ρ_{χ}_{₄}(χ₃) with cost m²

ø₅:χ₃→R⁺: base case with cost m. done.

Total computing: 4 * (4 * m³+m²+m) time, because ø_{c}=4.

Now, χₒₚₜ=(\dot{χ}₁, \dot{χ}₂, \dot{χ}₃, \dot{χ}₄, \dot{χ}₅, \dot{χ}₆) where

\dot{χ}₁=ρ_{χ}_{₁}(ρ_{χ}_{₄}(ρ_{χ}_{₃}()), ρ_{χ}_{₃}())

\dot{χ}₂=ρ_{χ}_{₄}(ρ_{χ}_{₃}())

\dot{χ}₃=ρ_{χ}_{₃}()

\dot{χ}₄=ρ_{χ}_{₄}(ρ_{χ}_{₄}(ρ_{χ}_{₃}()), ρ_{χ}_{₃}())

\dot{χ}₅=ρ_{χ}_{₅}(ρ_{χ}_{₃}(), ρ_{χ}_{₄}(ρ_{χ}_{₄}(ρ_{χ}_{₃}()), ρ_{χ}_{₃}()))

\dot{χ}₆=ρ_{χ}_{₆}(ρ_{χ}_{₁}(ρ_{χ}_{₄}(ρ_{χ}_{₃}()), ρ_{χ}_{₃}()), ρ_{χ}_{₃}())

computed from the above derivation.

1.4 Relaxation+Elimination Complexity Relationship

It is important to point out the advantage of relating ρ, the relaxation function and η, the vertex elimiation function. This relationship allows the complexity of the ARA problem to be made apparent. Formally, this can be stated in the follow theorem:

Let π be an ordering for G_{π} and R_{π} such that νᵢ=β(χᵢ). Then the computational complexity of a relaxation process R_{π} is O(Σ_{1≦i<n}m^{|N}^{_{ν}}^{ᵢ}^{|+1}), when it follows the vertex elimination process G_{π}. Note, that N_{ν}_{ᵢ} is the set of neighbors of νᵢ in Gᵢ.

Section 5.5 of Appendix A contains the proof of this theorem.

The value of the above theorem is that it allows the method to express the computational complexity of the solution to our optimization problem purely in terms of neighbors in the corresponding dependency graph.

Now, an order the vertices can be found to produce a small degree polynomial for the sum of complexities, O(Σ_{1≦i<n}m^{|N}^{_{ν}}^{ᵢ}^{|+1}), in terms of neighbors, performing the relaxation process in same order would yield a low degree polynomial solution for the optimization problem.

1.5 Alternatives to Tree Decomposition

There are a few alternate methods that can be employed instead of tree decomposition (step 24 of FIG. 3). Recall the goal is to find an optimal ordering of vertex elimination, which corresponds to an optimal relaxation order for the ARA problem.

Two ‘immediate’ greedy heuristics are described herein. Both algorithms take a graph generated previously via a dependency separation process and output a vertex ordering to guide the relaxation. Each can be used in place of performing tree decomposition.

The algorithms follow this structure (corresponding steps in FIG. 4C):

Greedy Elimination Ordering

1. Let i=0. (step 40)

2. Choose the next vertex k via a heuristic (see the two options below) (step 42)

3. Assign i+1 to k. (step 44)

4. Perform the vertex elimination on k—remove it from the graph and connect all of its neighbors (step 46)

5. If there are any more vertices, then go to step 1; otherwise, stop. (step 50)

1. Heuristic 1—Smallest Degree First

2. Find the vertex k with the least degree (if more than one, choose at random)

2. Heuristic 2—Least Edges Created

2. Find the vertex k such that the number of edges created after the relaxation of k is least. This value for any vertex j is

$$\frac{d * ( d - 1 )}{2} - m ,$$

where d=Deg[j] and m is the number of edges that exist between the neighbors of j.

The greedy method makes a locally optimal decision at each step, where the “best” vertex is chosen depending on the heuristic. The basic problem with this approach is the following: when a vertex is removed its former neighbors are fully connected and as a result can make the graph’ more complex than it needs to become. In the worst case, a what looks like a good local relaxation can unnecessarily create a new largest clique in the graph, making the total complexity proportional to its size. Since finding the largest clique in a graph is NP-complete, testing for an increase is hard.

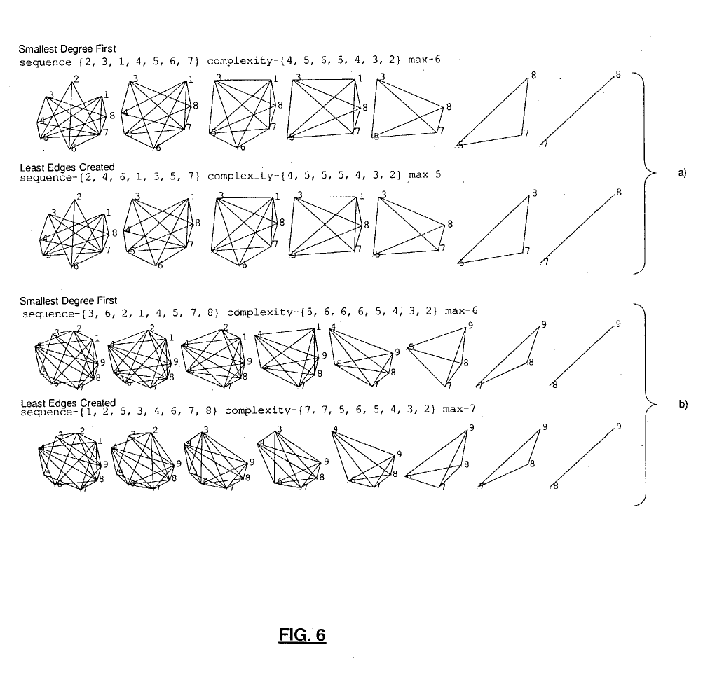

Neither heuristic is optimal and FIG. 6 demonstrates two counterexamples. The sequence set indicates the order in which the vertices are removed and the complexity set the corresponding cost to remove the variables in that order. The part a) of the figure shows a graph where the Least Edges heuristic is better. The b) graph shows that the Smallest Degree First is better. The sequences of graphs show how the dependency graphs evolve in response to the relaxation processes.

2 Distributed Service Commit

Another embodiment of the present invention is a method targeted at reserving resources in real-time and distributed environments. The method, called Distributed Service Commit (DSC), takes into account opportunity costs involved in holding reservation of resources and guarantees that all needed resources are either reserved all together or not at all. The atomic nature of the reservation model is necessary because the optimality of the resource assignments (obtained in the ARA method) is dependent upon the usage of all resources specified in the optimal solution. In one embodiment of the present invention, in conjunction with the ARA method, the consumer can select the best resources and reserve them in an atomic transaction.

The DSC solution method of the present invention comprises of algorithms for the consumer, resource and directory entities. Since it is a reservation model, the primary focus is on algorithms for the consumer, with algorithms for the other two being simple versions to handle basic transactions. The main focus is on the interaction between consumers and resources towards achieving an atomic agreement. A more detailed description of the Distributed Service Commit model and solution method is found in co-pending U.S. patent application Ser. No. 09/687,921, filed Oct. 13, 2000. The patent is hereby fully incorporated by reference.

2.1 Entities (Operational Overview)

2.1.1 Consumer

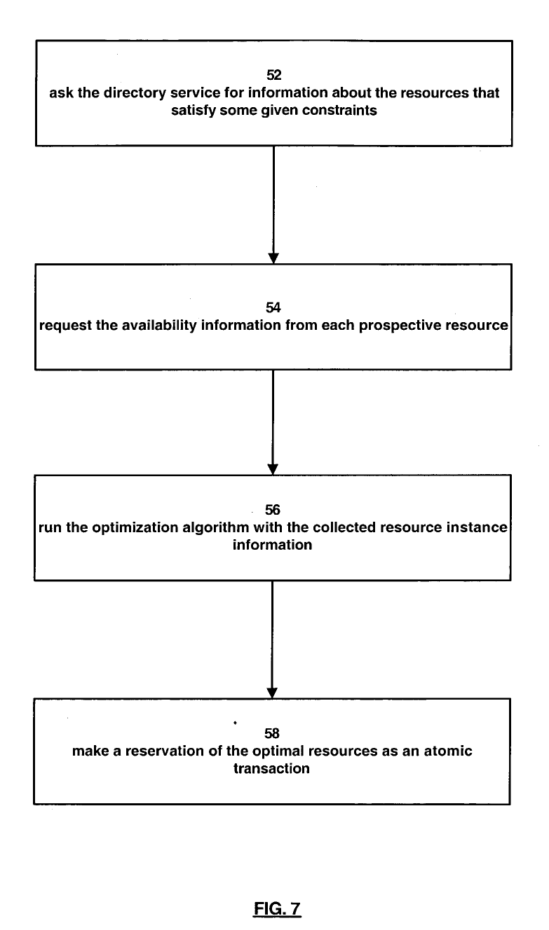

FIG. 7 presents a flowchart of how a consumer interacts with resources and a directory and its behavior. In the first step (step 52), the consumer seeks to locate all the resources that it could potentially use for its business process. To do this, it sends specifications of the resources it requires to a Directory. The directory returns a set of resource locators (URLs) that satisfy the consumer's constraints. For example, all the plumbers with at least 5 years experience within 20 miles of the construction site. If this set is empty (that is, the directory did not find any resources matching the query) then it is assumed that the client terminates (fails). In step 54, the consumer directly contacts the resources whose locators it acquired in step 52, asking for their availability information. The resources respond by sending back to the consumer lists of their available time slots and pricing information. At this stage, the consumer has all the information it needs about each resource to be able to determine which ones it could use best. In step 56, the consumer algorithm uses this information to find an optimal solution. Finally, in step 58, the consumer entity negotiates with the resources chosen in step 56 to perform reservations according business process specification.

2.1.2 Directory

A directory entity has a message loop and responds to messages from consumers. The single type of message expected by the directory is a query for resources based on a set of constraints. This is similar to a database lookup, where the consumer specifies the constraints in arbitrary detail and expects the directory to identify all the resources matching them. When a directory receives such a request, it queries its own internal database and possibly the databases of other directories and returns a (possibly empty) set of resources as a result.

2.1.3 Resource

A resource in the model registers with a directory so that consumers could find and consider it for their business processes. It then proceeds to wait for a message from a consumer. There are two categories of messages: information request and reservation/release messages. A resource receives the first type when a consumer in its step 54 asks for its availability. It replies to that by sending its availability time list. The second message type is invoked when a resource enters a negotiation for reservation. One type of reservation message requests a right for a consumer to reserve this resource some time in the future and to hold this right for some small amount of time (the Micro-Option request). The second is the actual reservation request (and an optional matching reservation release) if the consumer chooses to exercise their reservation option.

2.2 Distributed Transaction

The algorithm for commencing an atomic distributed reservation transaction between a resource and a consumer assumes that the consumer is at its final stage (step 58 of FIG. 7), where it has chosen a set of resources for reservation. The reservation is an atomic operation, such that either all the resources in the set become reserved or none of them. For instance, if a consumer has chosen the resources for a trip process and the return flight were not available when the consumer becomes ready to make a reservation, then he would not be interested in a partial reservation of just the unidirectional flight, a hotel and car. Only the reservation of the whole process is of interest.

The reason why such a reservation commitment is tricky is because the resource and the consumer entities are in a distributed system and the information they have about each other is always aged. In particular, the availability of a resource may have changed between the time a consumer has requested that information (in step 54) and the time of attempting the reservation. Thus, when the consumer attempts to make the reservation, it would fail for that resource. Because a process consists of a number of resources that all have to be reserved (or not reserved) together, it is not in a consumer's interest to start reserving a process and failing some time in the middle. To remedy this, one needs a mechanism that would give the consumer an insurance that its attempt at reserving a process would succeed with high probability (it is not possible to offer an absolute guarantee, since any entity in the system could, for example, lose its network connection, rendering it unreachable).

To remedy the problem, the present method embodiment uses a distributed atomic transaction based on a financial instrument called American Call Option. An option in the model is defined as a right, which can be purchased by a consumer, to reserve a resource for some specific time in the future. An option has a fixed expiration date T (the date when the right expires), a strike price K (the cost of the actual reservation) and a premium U (the amount a consumer must pay to purchase the right to reserve). An option, when purchased, is binding to the resource for which it was purchased, but it is not binding to the consumer. By buying an option for a resource, the consumer has a right, not an obligation to reserve that resource.

Using this reservation tool, it now becomes possible for a consumer to purchase short-lived tentative reservation commitments from resources by paying them to hold the time blocks that it is interested in. Now, the algorithm for the atomic reservation transaction can be outlined as follows.

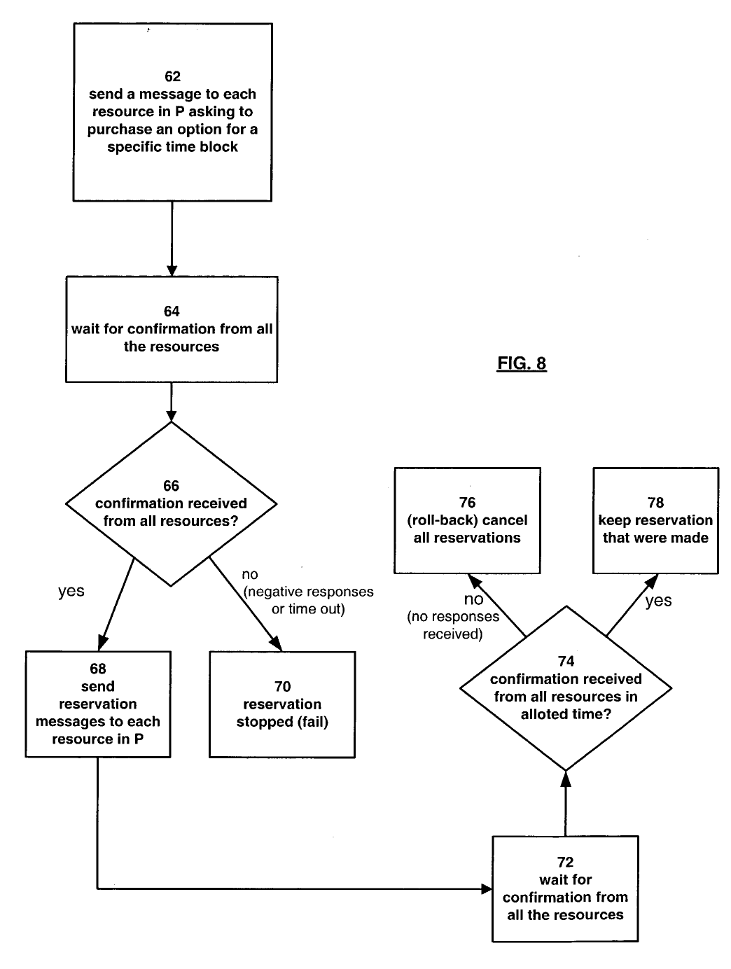

Suppose a consumer C wants to make a reservation of resources for some process P. Then it performs the steps shown in FIG. 8. In step 62, the consumer sends a message to each resource in P asking to purchase an option for a specific time block. Then in step 64, the consumer waits for confirmations from all the resources. It is determined in step 66 whether confirmation is received from each of the sources. The reservation is stopped (step 70 if a negative response is received or the wait times out with some of the resource confirmations missing. This means that the reservation has failed. Otherwise if confirmations are received from all resources, then the consumer sends reservation messages to each resource in P in step 68. Then it step 72, the consumer waits for a confirmation from all the resources. In step 74 it is determined whether all confirmations have been received. If no response is received from any of the resources in the allotted time, the consumer roll-backs (cancels all) the reservation in step 76. Otherwise, if all the confirmations are received, no action is necessary since all the reservation are already made (step 78).

Note that no explicit releasing of resources is necessary, since all reservations are done for a fixed amount of time. Option prices are going to be determined by the market and, in a free-market, likely to be close the opportunity cost. If the option costs are significant, the algorithm can be easily modified to consider only the sets of resources for which the consumer can afford to pay the reservation cost, namely, buying the options.

This algorithm ensures an atomic transaction between a consumer and a resource if 1) the conditions for commencing the actual resource reservations in step 68 have been met, 2) the option expiration date for the resources was sufficiently far into to the future for the reservation requests to reach the resources, and finally 3) the infrastructure was able to deliver the messages successfully.

In the sections that follow pseudo-code programs are given for the entities (consumer, directory, and resource). The code is a high level implementation of the functionality for each entity of the distributed system.

2.3 Program Notation

The presence of an infrastructure capable of delivering messages from one entity to the other is assumed here. The entities are entirely message-driven: each entity has an event loop constantly waiting for messages. When one arrives, an entity executes its program code to handle the message and immediately returns back to waiting. The messages received while an entity is handling an earlier message are queued in FIFO order and become available to the entity when it returns to the message loop.

The receive MessageName(M) time-out in X expression is used to denote the readiness of an entity to receive a message of type MessageName. Each message can be though of as a structure capable of carrying arbitrary information. When a message is processed (or accepted), its payload can be found in variable M. The message variable M also contains a special attribute, sender, referred to as M.sender, that identifies the source of the message. It is also assumed that a message can carry arbitrarily complex data—a list, a matrix, etc. If a receive statement has the time-out extension it signifies that the entity executing it should process messages of type MessageName until X units of time have expired. After that it should stop processing messages of this type and continue its computation. On the other hand, the receive statements without the time-out check the message queue of the calling entity and continue immediately if no messages matching their type are present.

The send M to E expression is used to signify the entity's intent on sending a message M to some other entity E. The send command is asynchronous and returns immediately, allowing the sending entity to continue its computation. The send M to E in X is an instruction to deliver message M to entity E in X time units. An entity can use this to send alarm messages to itself.

2.4 Programs

The following are the programs for the three entities in the model of the present invention:

Directory

1. wait for messages:

2. receive ResourceLocationsRequest(M):

3. R:=resources satisfying M.constraints in local database

4. send ResouceLocators(R.URL) to M.sender

Resource

1. Let A be a list of available time blocks

wait for messages:

receive AvailabilityRequestMessage(M):

send AvailabilityInformation(A) to M.sender;

receive ReserveOptionRequest(M):

if M.time block in A then // if block is available

remove M.time block from A; mark M.time block

as optioned;
send OptionExpired(M.time block) to self in M.dt; // set option expi-
ration alarm

charge M.sender for the option
send ReserveOptionCommit(M.time block) to M.sender;

end if

receive OptionExpired(M):

// check if the consumer has reserved its block
if(M.time block is not marked reserved) then

mark M.time block as free // option has expired
add M.time block to A // add it back to the free list
send OptionExpiredMessage(M) to M. sender

end if

receive ReservationRequestMessage(M):

if (M.time block in A OR M.time block marked optioned)

then

mark M.time block reserved
charge M.sender for the reservation
send ReservationSuccessfulMessage(M) to M.sender;

else

send ReservationFailedMessage(M) to M.sender;

receive ReservationCancellationMessage(M):

if (M.time block marked as reserved) then

add M.time block to A
unmark M.time block
charge M.sender for the cancellation

end if

Consumer

1. Let Resources be a list.

2. send ResourceLocationsRequest(graph, resource constraints) to Directory

wait for messages:

receive ResourceLocators(M) timeout in X:

for R in M.resources:

send AvailabilityRequestMessage to R;

end for

receive AvailabilityInformation (M) timeout in Y:

add M.information to Resources;

solution = Find optimal resources for the process; // see Chapter 5
// atomic reservation
for resource in solution do:

send ReserveOptionRequest(time block, dt) to resource;

end for
wait for messages:

receive ReserveOptionCommit(M) timeout in X:

mark resource as optioned

if all resources are optioned then:

for resource in process do:

send ReservationRequestMessage(time block) to resource;

end for

else

break;

end if
wait for messages:

receive ReservationSuccessfulMessage(M) timeout in X:

mark resource as reserved

if all resources are reserved then:

SUCCESS
exit;

else

FAILURE
// cancel all reservations and pay penalties
for resource in solution do:

send ReservationCancellationMessage(time block) to resource;

end for

end if

These programs provide an example implementation of the DSC solution.

3 Embodiment of Computer Execution Environment (Hardware)

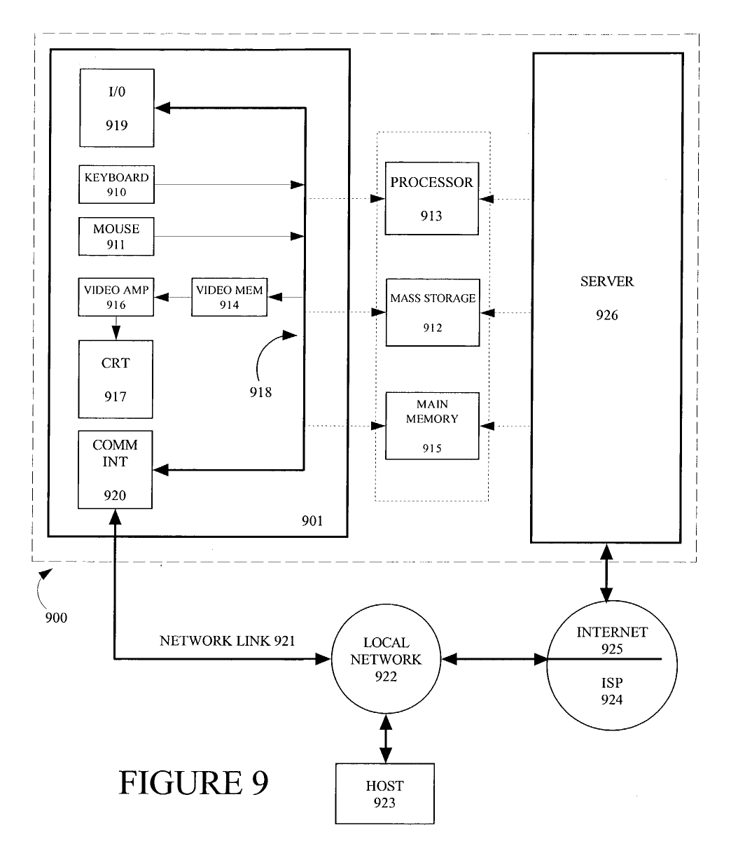

One or more embodiments of the present invention performs resource allocation and management are implemented in computer software running on a plurality of general purpose computing devices as shown in FIG. 9. A keyboard 910 and mouse 911 are coupled to a system bus 918. The keyboard and mouse are for introducing user input to the computer system and communicating that user input to central processing unit (CPU) 913. Other suitable input devices may be used in addition to, or in place of, the mouse 911 and keyboard 910. I/O (input/output) unit 919 coupled to bidirectional system bus 1018 represents such I/O elements as a printer, A/V (audio/video) I/O, etc.

Computer 901 may include a communication interface 920 coupled to bus 918. Communication interface 920 provides a two-way data communication coupling via a network link 921 to a local network 922. For example, if communication interface 920 is an integrated services digital network (ISDN) card or a modem, communication interface 920 provides a data communication connection to the corresponding type of telephone line, which comprises part of network link 921. If communication interface 920 is a local area network (LAN) card, communication interface 1020 provides a data communication connection via network link 921 to a compatible LAN. Wireless links are also possible. In any such implementation, communication interface 920 sends and receives electrical, electromagnetic or optical signals which carry digital data streams representing various types of information.

Network link 921 typically provides data communication through one or more networks to other data devices. For example, network link 921 may provide a connection through local network 922 to local server computer 923 or to data equipment operated by ISP 924. ISP 924 in turn provides data communication services through the world wide packet data communication network now commonly referred to as the “Internet” 925. Local network 922 and Internet 925 both use electrical, electromagnetic or optical signals which carry digital data streams. The signals through the various networks and the signals on network link 921 and through communication interface 920, which carry the digital data to and from computer 900, are exemplary forms of carrier waves transporting the information.

Processor 913 may reside wholly on client computer 901 or wholly on server 926 or processor 913 may have its computational power distributed between computer 901 and server 926. Server 926 symbolically is represented in FIG. 9 as one unit, but server 926 can also be distributed between multiple “tiers”. In one embodiment, server 926 comprises a middle and back tier where application logic executes in the middle tier and persistent data is obtained in the back tier. In the case where processor 913 resides wholly on server 926, the results of the computations performed by processor 913 are transmitted to computer 901 via Internet 925, Internet Service Provider (ISP) 924, local network 922 and communication interface 920. In this way, computer 901 is able to display the results of the computation to a user in the form of output.

Computer 901 includes a video memory 914, main memory 915 and mass storage 912, all coupled to bi-directional system bus 918 along with keyboard 910, mouse 911 and processor 913. As with processor 913, in various computing environments, main memory 915 and mass storage 912, can reside wholly on server 926 or computer 901, or they may be distributed between the two. Examples of systems where processor 913, main memory 915, and mass storage 912 are distributed between computer 901 and server 926 include the thin-client computing architecture, personal digital assistants, Internet ready cellular phones and other Internet computing devices.

The mass storage 912 may include both fixed and removable media, such as magnetic, optical or magnetic optical storage systems or any other available mass storage technology. Bus 918 may contain, for example, thirty-two address lines for addressing video memory 914 or main memory 915. The system bus 918 also includes, for example, a 32-bit data bus for transferring data between and among the components, such as processor 913, main memory 915, video memory 914 and mass storage 912. Alternatively, multiplex data/address lines may be used instead of separate data and address lines.

In one embodiment of the invention, the processor 913 can be any suitable microprocessor or microcomputer. Main memory 915 is comprised of dynamic random access memory (DRAM) or other equivalent memory types. Video memory 914 is a dual-ported video random access memory. One port of the video memory 914 is coupled to video amplifier 916. The video amplifier 916 is used to drive the cathode ray tube (CRT) raster monitor 917. Video amplifier 916 is well known in the art and may be implemented by any suitable apparatus. This circuitry converts pixel data stored in video memory 914 to a raster signal suitable for use by monitor 917. Monitor 917 is a type of monitor suitable for displaying graphic images.

Computer 901 can send messages and receive data, including program code, through the network(s), network link 921, and communication interface 920. In the Internet example, remote server computer 926 might transmit a requested code for an application program through Internet 925, ISP 924, local network 922 and communication interface 920. The received code may be executed by processor 913 as it is received, and/or stored in mass storage 912, or other non-volatile storage for later execution. In this manner, computer 900 may obtain application code in the form of a carrier wave. Alternatively, remote server computer 926 may execute applications using processor 913, and utilize mass storage 912, and/or video memory 915. The results of the execution at server 926 are then transmitted through Internet 925, ISP 924, local network 922 and communication interface 920. In this example, computer 901 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

Thus, a method for automating resource management is described in conjunction with one or more specific embodiments. The invention is defined by the following claims and their full scope of equivalents.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

We claim:

1. A method for automating resource management, comprising the steps of:
mapping a business process to an optimization model;
analyzing the structure of said optimization model to obtain complexity information and relaxation ordering from said structure; and
solving for an optimal assignment for said optimization model.

2. The method of claim I wherein said step of analyzing the structure further comprises:
performing a dependency separation on said optimization model;
creating a dependency graph; and
obtaining a relaxation order and complexity information from said dependency graph.

3. The method of claim 2 wherein said polynomial degree of said complexity information is approximately equal to the size of the largest clique in said dependency graph.

4. The method of claim 2 wherein said polynomial degree of said complexity information is equal to
$$O ( {\sum }_{1 \leq i \leq n}^{} {m}^{\vert {N}_{{v}_{i}} \vert + 1} ) ,$$
wherein n is the number of vertices in said dependency graph and N_{ν}_{ᵢ} is the set of neighbors of νᵢ in said dependency graph at the time when νᵢ is relaxed.

5. The method of claim 4 wherein said step of obtaining a relaxation order further comprises:
choosing between a tree-decomposition method and a heuristic method to obtain said relaxation based on said complexity information.

6. The method of claim 2 wherein said step of obtaining a relaxation order from said dependency graph further comprises:
creating a decomposition tree based on the structure of said dependency graph; and
performing vertex elimination on said dependency graph by iterating through the tree leaves, whereby a relaxation order is obtained through the order in which the vertices are eliminated.

7. The method of claim 6 wherein said step of performing vertex elimination further comprises:
finding a vertex that appears in exactly one leaf in said decomposition tree;
removing said vertex;
removing said leaf from said decomposition tree if said leaf is equal to its parent leaf after the removal of said vertex.

8. The method of claim 7 wherein said step of removing said vertex further comprises:
removing said vertex and all edges connected to said vertex from said dependency graph; and
connecting all neighbor vertices of said vertex with edges.

9. The method of claim 6 wherein the polynomial degree of said complexity information is approximately equal to the tree-width of said decomposition tree.

10. The method of claim 2 wherein said step of obtaining a relaxation order further comprises:
using a heuristic to select the order of vertex removal.

11. The method of claim 10 wherein said step of using a heuristic further comprises:
setting a counter variable to a beginning value;
choosing a vertex via a heuristic, numbering it by a choosing variable;
incrementing said counter variable by one and assigning the result to said choosing variable; and
performing vertex elimination on said chosen vertex by removing it from said dependency graph and connecting all of its neighbors, whereby a relaxation order is obtained through the order in which the vertices are eliminated.

12. The method of claim 11 wherein said heuristic chooses a vertex with the least degree.

13. The method of claim 11 wherein said heuristic chooses a vertex such that the number of edges created is least after relaxation of said vertex.

14. The method of claim 2 wherein said step of solving further comprises:
performing relaxation of each variable in said optimization model using said obtained relaxation order.

15. The method of claim 14 wherein said step of performing relaxation further comprises:
relaxing each of said variable until only the last variable remains;
solving for the optimal assignment for said last variable; and
using said optimal assignment for said last variable to solve recursively for other variables in said model.

16. The method of claim 15 wherein said step of relaxing preserves at least one optimal solution.

17. The method of claim 1 wherein said optimization model comprises:
a plurality of variables;
a plurality of relationship functions; and
an objective function.

18. The method of claim 17 wherein said plurality of variables represent a plurality of available resources that can perform the required tasks in said business process.

19. The method of claim 17 wherein said plurality of relationship functions represent consumer preferences in said business process.

20. The method of claim 17 wherein said objective function is an algebraic composition of said plurality of relationship functions.

21. The method of claim 1 wherein said step of analyzing the structure takes linear time.

22. The method of claim 1 further comprises the step of:
determining whether to perform said step of solving based on said obtained complexity information of said optimization model.

23. A method for automating resource management, comprising the steps of:
querying a directory service for information about a plurality of prospective resources that satisfy some given constraints;
requesting the availability informing from each of said prospective resources;
running an optimization algorithm with said collected information from said directory service; and
making a reservation of the optimal resources as an atomic transaction.

24. The method of claim 23 wherein said step of running an optimization algorithm further comprises:
mapping said constraints and prospective resources to an optimization model;
analyzing the structure of said optimization model to obtain complexity information and relaxation ordering from said structure; and
solving for an optimal assignment for said resources in said optimization model.

25. The method of claim 23 wherein said step of making a reservation of the optimal resources as an atomic transaction further comprises:
asking to purchase, from each of said prospective resources, an option for a specific time block;
waiting for a first confirmation from each of said prospective resources;
sending a reservation to each of said prospective resources, if said first confirmation is received from each of said prospective resources;
waiting for a second confirmation from each of said prospective resources.

26. The method of claim 25 further comprises the step of:
canceling all reservation to all prospective resources if said second confirmation is not received from each of said prospective resources.

27. The method of claim 23 wherein said directory service is a computer database on a computer network.

28. A computer program product comprising:
a computer usable medium having computer readable program code means embodied in said medium for causing a computer to automate resource management, said computer readable program code means comprising:
computer readable program code means for causing a computer to map a business process to an optimization model;
computer readable program code means for causing a computer to analyze the structure of said optimization model to obtain complexity information and relaxation ordering from said structure; and
computer readable program code means for causing a computer to solve for an optimal assignment for said optimization model.

29. The computer program product of claim 28 wherein said computer readable program code means for causing a computer to analyze the structure further comprises:
computer readable program code means for causing a computer to perform a dependency separation on said optimization model;
computer readable program code means for causing a computer to create a dependency graph; and
computer readable program code means for causing a computer to obtain a relaxation order and complexity information from said dependency graph.

30. The computer program product of claim 29 wherein said polynomial degree of said complexity information is approximately equal to the size of the largest clique in said dependency graph.

31. The computer program product of claim 29 wherein said polynomial degree of said complexity information is equal to
$$O ( {\sum }_{1 \leq i \leq n}^{} {m}^{\vert {N}_{{v}_{i}} \vert + 1} ) ,$$
wherein n is the number of vertices in said dependency graph and N_{ν}_{ᵢ} is the set of neighbors of νᵢ in said dependency graph at the time when νᵢ is relaxed.

32. The computer program product of claim 31 wherein said computer readable program code means for causing a computer to obtain a relaxation order further comprises:
computer readable program code means for causing a computer to choose between a tree-decomposition method and a heuristic method to obtain said relaxation based on said complexity information.

33. The computer program product of claim 29 wherein said computer readable program code means for causing a computer to obtain a relaxation order from said dependency graph further comprises:
computer readable program code means for causing a computer to create a decomposition tree based on the structure of said dependency graph; and
computer readable program code means for causing a computer to perform vertex elimination on said dependency graph by iterating through the tree leaves, whereby a relaxation order is obtained through the order in which the vertices are eliminated.

34. The computer program product of claim 33 wherein said computer readable program code means for causing a computer to perform vertex elimination further comprises:
computer readable program code means for causing a computer to find a vertex that appears in exactly one leaf in said decomposition tree;
computer readable program code means for causing a computer to remove said vertex;
computer readable program code means for causing a computer to remove said leaf from said decomposition tree if said leaf is equal to its parent leaf after the removal of said vertex.

35. The computer program product of claim 34 wherein said computer readable program code means for causing a computer to remove said vertex further comprises:
computer readable program code means for causing a computer to remove said vertex and all edges connected to said vertex from said dependency graph; and
computer readable program code means for causing a computer to connect all neighbor vertices of said vertex with edges.

36. The computer program product of claim 33 wherein the polynomial degree of said complexity information is approximately equal to the tree-width of said decomposition tree.

37. The computer program product of claim 29 wherein said computer readable program code means for causing a computer to obtain a relaxation order further comprises:
computer readable program code means for causing a computer to use a heuristic to select the order of vertex removal.

38. The computer program product of claim 37 wherein said computer readable program code means for causing a computer to use a heuristic further comprises:
computer readable program code means for causing a computer to set a counter variable to a beginning value;
computer readable program code means for causing a computer to choose a vertex via a heuristic, numbering it by a choosing variable;
computer readable program code means for causing a computer to increment said counter variable by one and assigning the result to said choosing variable; and
computer readable program code means for causing a computer to perform vertex elimination on said chosen vertex by removing it from said dependency graph and connecting all of its neighbors, whereby a relaxation order is obtained through the order in which the vertices are eliminated.

39. The computer program product of claim 38 wherein said heuristic chooses a vertex with the least degree.

40. The computer program product of claim 38 wherein said heuristic chooses a vertex such that the number of edges created is least after relaxation of said vertex.

41. The computer program product of claim 29 wherein said computer readable program code means for causing a computer to solve further comprises:
computer readable program code means for causing a computer to perform relaxation of each variable in said optimization model using said obtained relaxation order.

42. The computer program product of claim 41 wherein said computer readable program code means for causing a computer to perform relaxation further comprises:
computer readable program code means for causing a computer to relax each of said variable until only the last variable remains;
computer readable program code means for causing a computer to solve for the optimal assignment for said last variable; and
computer readable program code means for causing a computer to use said optimal assignment for said last variable to solve for other variables in said model.

43. The computer program product of claim 42 wherein said computer readable program code means for causing a computer to relax preserves at least one optimal solution.

44. The computer program product of claim 28 wherein said optimization model comprises:
a plurality of variables;
a plurality of relationship functions; and
an objective function.

45. The computer program product of claim 44 wherein said plurality of variables represent a plurality of available resources that can perform the required tasks in said business process.

46. The computer program product of claim 44 wherein said plurality of relationship functions represent consumer preferences in said business process.

47. The computer program product of claim 44 wherein said objective function is an algebraic composition of said plurality of relationship functions.

48. The computer program product of claim 28 wherein said computer readable program code means for causing a computer to analyze the structure takes linear time.

49. The computer program product of claim 28 further comprises:
computer readable program code means for causing a computer to determine whether to perform said step of solving based on said complexity of said optimization model.

50. A computer program product comprising:
a computer usable medium having computer readable program code means embodied in said medium for causing a computer to automate resource management, said computer readable program code means comprising:
computer readable program code means for causing a computer to query a directory service for information about a plurality of prospective resources that satisfy some given constraints;
computer readable program code means for causing a computer to request the availability informing from each of said prospective resources;
computer readable program code means for causing a computer to run an optimization algorithm with said collected information from said directory service; and
computer readable program code means for causing a computer to make a reservation of the optimal resources as an atomic transaction.

51. The computer program product of claim 50 wherein said computer readable program code means for causing a computer to run an optimization algorithm further comprises:
computer readable program code means for causing a computer to map said constraints and prospective resources to an optimization model;
computer readable program code means for causing a computer to analyze the structure of said optimization model to obtain complexity information and relaxation ordering from said structure; and
computer readable program code means for causing a computer to solve for an optimal assignment for said resources in said optimization model.

52. The computer program product of claim 50 wherein said computer readable program code means for causing a computer to make a reservation of the optimal resources as an atomic transaction further comprises:
computer readable program code means for causing a computer to ask to purchase, from each of said prospective resources, an option for a specific time block;
computer readable program code means for causing a computer to wait for a first confirmation from each of said prospective resources;
computer readable program code means for causing a computer to send a reservation to each of said prospective resources, if said first confirmation is received from each of said prospective resources;
computer readable program code means for causing a computer to wait for a second confirmation from each of said prospective resources.

53. The computer program product of claim 52 further comprises:
computer readable program code means for causing a computer to cancel all reservation to all prospective resources if said second confirmation is not received from each of said prospective resources.

54. The computer program product of claim 50 wherein said directory service is a computer database on a computer network.
